(19) United States
(12) Patent Application Publication
(10) Pub. No.: US 2019/0322591 A1
(43) Pub. Date: Oct. 24, 2019

(54) Transparent Composite Material

(71) Applicant: CeramTec-ETEC GmbH, Lohmar (DE)

(72) Inventors: Lars SCHNETTER, Wimbach (DE); Lukas BREDE, St. Katharinen (DE); Helen ESCHENAUER, Westerburg (DE)

(21) Appl. No.: 16/471,937

(22) PCT Filed: Dec. 12, 2017
(86) PCT No.: PCT/EP2017/082312

§ 371 Date: Jun. 20, 2019

(30) Foreign Application Priority Data
Dec. 14, 2016 (DE) 10 2016 224 897.9

(51) Int. Cl. C04B 37/04; E04F 15/08; B32B 18/00; B32B 15/04; B32B 9/00

(52) U.S. Cl. CPC C04B 37/042; E04F 15/08; B32B 18/00; F41H 5/0407; B32B 9/005; C04B 2237/343; C04B 2237/70; B32B 15/04

(57) ABSTRACT

The invention relates to a transparent composite material for various applications, having crystalline and amorphous inorganic materials with improved material properties.

The present invention relates to a transparent composite material for various applications, consisting of a crystalline and amorphous material having new material properties.

In general, optical components and parts consist of glass, glass ceramics, plastics material, monocrystals or polycrystalline ceramics. The group of the monocrystals and polycrystalline ceramics are of constantly increasing interest and market potential, since they have advantages such as greater scratch resistance, shape retention, temperature resistance, flexural strength, and greater resistance to aggressive media, compared with glass, glass ceramics and plastics materials.

However, glass, glass ceramics and plastics materials are materials that are available in large quantities and in a range of types, and can often be produced more cost-effectively than transparent ceramics.

A compound consisting of glass, glass ceramics or plastics material, together with monocrystals or polycrystalline ceramics, by means of organic intermediate layers or bonding agents (adhesives) is known as a possible more cost effective variant. WO 2015/1 18079 A1 describes a component that consists of a substrate, a polycrystalline functional layer (thickness <2 mm), and a bonding agent. An adhesive having a refractive-index adjusted index of refraction is cited as the bonding agent, which adhesive mediates between the substrate and the functional layer and reduces light reflection by adapting the phase transitions. DE 10 201 1 014 100 A1 describes a component that consists of a cover layer of polycrystalline ceramics or monocrystals, a refractive-index adjusted adhesive as the matrix material, and a glass pane. For individual applications (see the usage examples below), the use of organic adhesives may have a disadvantageous effect in terms of the temperature, chemical and environmental resistance.

In the field of personal protection, transparent monocrystals or polycrystalline ceramics that are adhesively bonded to glass and/or plastics materials have better ballistic protection performance than glass or plastics materials per se. In this case, a tile composite consisting of individual tiles (up to 400×400 mm in size) is expedient. However, said tile composite construction requires bonding by means of organic adhesives having indices of refraction adjusted to the material in order to entirely prevent light reflections and visibility of phase transitions.

Owing to the above-mentioned disadvantages, this adhesive bonding technique can be implemented only to a limited extent in the overall system, because joining in autoclaves is already associated with extreme conditions, or direct exposure to the environment may be problematic (UV resistance and chemical resistance).

Use in the architectural field (for example glass surfaces that can be walked on) also requires large surfaces which can particularly preferably be created by bonding individual ceramics elements or tiles. Bonding the tiles however, results in the edges being visible, which is seldom desirable aesthetically. However, the sometimes disadvantageous environmental resistance limits the use of adhesives based on organic polymers (stress from weather conditions, saltwater, etc.).

Civil applications of transparent materials, such as the use as screen covers for smartphones, notepads or smart watches, require excellent optical and mechanical properties. Furthermore, thin designs of components are necessary, which designs are in the range of <2000 μm, usually even <1000 μm or even <500 μm in the smartphone sector. In the case of these thin wall thicknesses, screen protectors can bend because the flexural rigidity dramatically decreases at the rate of the cube of the thickness.

The object of the present invention is that of providing a composite material that does not exhibit the above-mentioned disadvantages, and in particular has a flexural strength that is improved compared with crystalline materials, and has improved chemical, temperature and environmental resistance compared with composite materials comprising organic intermediate layers.

The object is achieved by a composite material according to claim 1. Preferred embodiments are set out in the dependent claims. The embodiments can be combined with one another.

The composite material according to the invention has improved properties. Said material combines the advantages of the various material classes with on another in a particular manner, and equalizes deficiencies of the materials in question.

This is made possible by a transparent composite material that is characterized in that an amorphous inorganic material is directly or integrally bonded to a transparent crystalline inorganic material. The amorphous inorganic material is formed together with the transparent crystalline inorganic material, by means of transient bonding between softened amorphous inorganic material and crystalline inorganic material. After cooling, an integral bond having a particular chemical bond, including an ionic bond fraction, is achieved. Within the meaning of the present invention, a direct bond means a joining bond between the amorphous inorganic material and the transparent, crystalline inorganic material, without using an organic intermediate layer or a bonding agent. According to the invention, a transient bond is understood to mean that the softened amorphous inorganic material is bonded to the transparent crystalline amorphous material, and a joining bond forms. After cooling, an integral, i.e. chemical, bond is achieved in the region of the transient bond. The softening of the amorphous inorganic material is preferably achieved by the action of temperature. The transparent crystalline inorganic material will be referred to in the following as a crystalline inorganic material.

The composite material according to the invention consists of at least one layer of an amorphous inorganic material and at least one layer of a transparent crystalline inorganic material. A layer is understood to mean an extensive shape, a tile, plate or slab, or a 3-dimensional shape. A layer within the meaning of the invention is a part that can be handled and that has geometrical dimensions. When a plurality of layers of the transparent crystalline inorganic material, in particular a transparent ceramic, are provided on top of one another, the overall thickness of the plurality of layers is preferably >20 mm, more preferably >30 mm, and particularly preferably >40 mm.

The at least one layer, in each case, of the amorphous inorganic material and of the transparent crystalline inorganic material, present according to the invention, are provided on top of one another in one embodiment. In this case, on top of one another means that the large flat side of a layer of the amorphous inorganic material is bonded to a large flat side of a layer of the crystalline inorganic material. This is surface joining. If a plurality of layers of each of the amorphous inorganic material and of the crystalline inorganic material are provided, said layers are preferably arranged alternately. This is a sandwich of at least 2 different materials. According to the invention, a sandwich composite is a composite material in which a glass layer is applied to a ceramics layer, to which glass layer a further ceramics layer is in turn applied.

The at least one layer, in each case, of the amorphous inorganic material and of the transparent crystalline inorganic material, present according to the invention, are provided side-by-side in a further embodiment. In this case, side-by-side means that the narrow flat sides of the amorphous inorganic material and of the crystalline inorganic material adjoin one another. This is edge joining. If more than one layer, in each case, of the two materials is provided, this arrangement preferably resembles a checkerboard.

According to the invention, in a further embodiment the layer of the transparent crystalline inorganic material is provided so as to be surrounded by a layer of the amorphous inorganic material, at least in part. In this case, surrounded means that the edges of the amorphous inorganic material and of the crystalline inorganic material adjoin one another, and that the amorphous inorganic material is located between the edges of the crystalline inorganic material. This embodiment is similar to a composite consisting of slabs (=crystalline inorganic material, also referred to as tiles or plates), and joints (=amorphous inorganic material). This is again edge joining.

In a further embodiment, the layer of the crystalline inorganic material is embedded in the amorphous inorganic material. In this case, embedded means that the amorphous inorganic material encloses the crystalline inorganic material at least in part, and preferably completely. Edge joining, and surface joining, at least in part, are provided.

A composite material according to the invention can contain the different arrangements of the various materials.

The amorphous material is selected from glass and/or metal. The crystalline material is selected from monocrystals and/or polycrystalline ceramics. Polycrystalline ceramics are selected from a list of oxides of the compounds comprising Al and/or Mg and/or yttrium; nitrides, oxynitrides or sulfides of aluminum or silicon; oxides of zirconium and/or yttrium, aluminum oxynitride; zinc sulfide; silicon carbide, boron carbide, boron nitride, carbon, lanthanum-doped lead zirconate titanate, or fluoride of Ca and/or Mg and/or aluminum having up to 5% dopants of the group consisting of the lanthanoids and/or actinides and/or ferrous or non-ferrous metals, or mixtures thereof. For the present invention, a cubic polycrystalline oxide ceramics of the system of aluminum, aluminum-magnesium or aluminum-yttrium, or zirconium oxide or zirconium oxide-yttrium, or aluminum oxynitride, is preferred.

In an embodiment of the composite material, amorphous inorganic layers of different materials are provided, in a manner separated by a layer of a crystalline inorganic material. In a further embodiment of the composite material, crystalline inorganic layers of different materials are provided, in a manner separated by a layer of an amorphous inorganic material.

In a further embodiment, the amorphous inorganic layers of different materials are provided as graduated layers, i.e. layers provided with a gradient. This embodiment appears primarily in the case of surface joining.

The amorphous inorganic material of a layer is directly bonded to the transparent crystalline inorganic material of the adjacent layer, by means of a transient bond that has been formed between softened inorganic material and crystalline material, preferably by using a vacuum furnace, a normal furnace (an atmospheric furnace, i.e. a gas-fired or electric furnace under normal terrestrial atmosphere), a thermal tempering furnace, a heating press, a hot isostatic press, or a fast sintering method such as Field Assisted Sintering Technology or Spark plasma sintering. In this case, a reaction zone can form at the point where the amorphous material and the crystalline material meet. After cooling, an integral bond or an integral/chemical bond is achieved. In an embodiment, the resultant material has mechanical stresses in the amorphous inorganic fraction and/or in the transparent crystalline ceramics fraction, which stresses are a result of differences in the coefficients of thermal expansion of the materials. In an embodiment, compressive stress is present in the amorphous fraction, at least in part, and in a further embodiment compressive stress is present in the crystalline fraction, at least in part, and in a preferred embodiment compressive stress is present in both materials, at least in part. In a preferred embodiment of the invention, the crystalline material fraction of the composite material has a compressive stress of >10 MPa, preferably >100 MPa, and particularly preferably >300 MPa, at least in part, after joining. In a further embodiment, the amorphous material has a compressive stress of >10 MPa, preferably >100 MPa, and particularly preferably >300 MPa, at least in part. In a further preferred embodiment, the crystalline inorganic material fraction and the amorphous inorganic material fraction each have a compressive stress of >10 MPa, preferably >100 MPa, and particularly preferably >300 MPa, at least in part.

The chemical bond preferably forms when the amorphous inorganic material has a minimum viscosity of log(ηn)≤15, preferably log(ηn)≤13, particularly preferably log(η)≤8 during joining. The unit of the viscosity ₙ is usually poise or dPas (1 poise=1 dPas, i.e. e.g. η=10¹⁵ poise or dPas). The amorphous inorganic material is heated. This is particularly advantageous because the amorphous material softens. In the process, the viscosity of the amorphous material also changes. A characteristic temperature is the lower relaxation limit or the softening point T_{G}. In the latter case, a progressive length increase generally takes place, which increase is measured in dilatometric experiments. Above T_{G}, the volume increases significantly, since the coefficient of thermal expansion increases until the material fully softens, which can also be used in order to increase the stress.

As the temperature increases, the wetting of the materials and the diffusion coefficients are also promoted. As a result, the at least two layers from which the composite material consists ideally do not need to have an extremely high-quality surface finish (e.g. smoothed, polished, finely polished) at the joining points. The composite material can preferably be created by joining polished surfaces having a roughness Ra of <1 [m, preferably <0.1 μm, and particularly preferably <0.01 μm. The composite material can generally be produced within the transformation range of the amorphous inorganic material, for example glass. When the above-mentioned viscosity of log(η)≤15, preferably log(η)≤13, more preferably log(η)≤8 of the at least one amorphous inorganic material is exceeded, the composite material results. In a preferred embodiment, the layer of the amorphous inorganic material compensates for the unevenness on the layer of the crystalline inorganic material.

In particular for the requirements in the field of personal protection, for example safety windows or architectural glass, the composite material according to the invention provides a surprisingly comprehensive solution which overcomes the issues and problems existing hitherto.

In an embodiment, the composite material is created only by integral (chemical) bonding of at least one layer of amorphous inorganic material to at least one layer of crystalline inorganic material. Since a layer of a bonding agent, for example an organic adhesive, is omitted, the often problematic environmental resistance of the bonding agent is not a problem.

In an alternative embodiment, the composite material is formed of at least three layers, both by integral bonding of at least one layer of amorphous inorganic material to at least one layer of crystalline inorganic material, and by means of a bonding agent layer between at least two layers within the composite material. The at least two layers bonded by means of the bonding agent are the same or different in terms of the material.

The solution according to the invention is thus a composite material on the basis of chemical, integral bonding of at least two materials (amorphous and crystalline, i.e. for example glass and ceramics).

It has been found in this case that, according to the invention, selecting an amorphous inorganic material, preferably a glass, which has an index of refraction of >1.6, preferably ≥1.65, and particularly preferably ≥1.7, said material in particular having an index of refraction in the VIS range which corresponds to that of the crystalline material (e.g. n=1.7±0.03 for magnesium aluminum spinel) and which has coefficients of thermal expansion (CTE) that is no more than 0.5·10⁻⁶ K⁻¹ greater than that of the crystalline material, makes it possible for an environmentally stable, optically homogeneous and ballistically higher performance, extensive composite material to be produced. The CTE are defined as the average thermal alpha (difference of the relative length change) between two temperatures. The CTE is measured in connecting rod dilatometers. In an embodiment, the composite material is provided in an extensive form, owing to the edge joining in each case of at least one layer of the amorphous inorganic material and of the crystalline inorganic material. In this case, extensive refers to the surface that is achieved by the at least two adjacent layers.

The CTE of the amorphous material is greater than, less than or equal to, preferably equal to, the CTE of the crystalline inorganic material.

In an embodiment, the CTE of the materials used, of two successive layers consisting of amorphous inorganic material and crystalline inorganic material, having surface and/or edge joining, have a CTE difference ΔCTE, at temperatures of 20-300° C., of ≥0.1·10⁻⁶ K⁻¹, preferably ΔCTE≥3·1⁻⁶ K⁻¹, particularly preferably ΔCTE≥6·10⁻⁶ K⁻¹, and the CTE of the amorphous inorganic material, in particular of the glass, is less than the CTE of the crystalline inorganic material, in particular of the transparent ceramics. As a result, compressive stress is achieved at the join zone, i.e. the zone in which the amorphous inorganic material meets the crystalline inorganic material or the region that is forming and in which the amorphous inorganic material and the crystalline inorganic material are bonded together.

In an alternative embodiment, a comparable effect can be achieved between the two temperatures of 20-T(log(η)=15)° C., i.e. the temperature at which the glass has a viscosity of Ig(η)=15, and a ΔCTE of ≥0.5·10⁻⁶ K⁻¹, preferably ΔCTE≥3·10⁻⁶K⁻¹, particularly preferably ΔCTE≥6·10⁻⁶ K⁻¹, the CTE of the amorphous inorganic material being less than the CTE of the crystalline inorganic material.

Using amorphous inorganic materials which are adjusted, with respect to the index of refraction, to the crystalline inorganic materials, i.e. are similar to, preferably correspond to, the index of refraction of the crystalline inorganic materials, makes it possible to prevent optical interference occurring in the material. That is to say that total internal reflection does not take place at the boundary layers of the transition from the amorphous inorganic material to the crystalline inorganic material. Glass is therefore preferred as the amorphous inorganic material. In the case of crystalline tiles comprising different materials, which tiles are conventionally bonded by means of bonding agents, total internal reflection often occurs, in particular when viewed perpendicularly, and results in reflection in the region of the bonding zone, even at a deviation in the index of refraction of Δn≥0.02 (njoin zone<nceramics). Furthermore, in contrast to the composites known from the prior art, comprising bonding agents, the composite material also has long-term environmental stability, i.e. even in the case of direct exposure to the environment. In addition, said composite material can also withstand the autoclaving process.

There is a wide selection of the amorphous inorganic materials, preferably the glass, despite the high indices of refraction, which materials are necessary, in the composite material according to the invention, for combining with crystalline inorganic materials such as spinel (MgAl₂O₄) (n=1.72) or sapphire (Al₂O₃) (n=1.76) or yttrium-aluminum garnet (YAG), where n>1.8. Said glass achieves the high indices of refraction as a result of high fractions of barium, lead, sulfur or lanthanum. The glass is therefore preferably selected from lanthanum crown glass (LAK), lanthanum flint glass (LaF), lanthanum dense flint (LaSF), barium dense flint (BaSF), dense flint glasses (NSF) and/or barium flint glasses (BaF). Said glass ensures excellent UV resistance, moisture resistance, strength and a wide range of possible variations with respect to the CTE and to the transformation temperatures. High chemical resistance can also be achieved using this glass. In an embodiment, the amorphous material is a glass comprising 0-15 mol. % lanthanum, 0-15 mol. % lead, 0-15 mol. % barium, and boron, silicon and/or aluminum and/or boron. In a preferred embodiment, the amorphous inorganic material is a glass comprising >0 to 15 mol. % lanthanum, and/or >0 to 15 mol. % lead, and/or >0 to 15 mol. % barium. The glass preferably furthermore contains boron, silicon and/or aluminum.

In a further preferred embodiment, the amorphous inorganic material is a glass comprising 10-50 wt. % lanthanum oxide, 1-20 wt. % calcium oxide, 25-45 wt. % boron oxide. Said glass can preferably additionally contain barium oxide, antimony oxide, magnesium oxide, silicon oxide, strontium oxide, titanium oxide, zinc oxide, yttrium oxide, and/or zirconium oxide, or mixtures thereof.

In a preferred embodiment, the indices of refraction of the amorphous inorganic material and of the crystalline inorganic material deviate from one another by less than 0.4, preferably by less than 0.2, and particularly preferably by less than 0.15 at λ=550-650 nm. This is preferably tolerated in the case of surface joining.

In a further embodiment, the composite material is formed of a plurality of layers in the form of slabs of the crystalline inorganic material, preferably the ceramics, preferably of a size of from 20×20 mm to 300×300 mm, particularly preferably of 20×20 mm and/or 300×300 mm, preferably quadratic, as a polygon or as a rectangle, which are surrounded by a matrix of the amorphous inorganic material. This results in a smooth, preferably planar, surface. In addition to the optics and the environmental resistance of the composite material, this design also optimizes the ballistic performance beyond that of existing solutions. The layers of the crystalline inorganic material are bonded by the amorphous inorganic material, within the meaning of slabs and joints. Reducing the composite width, i.e. reducing the width of the joint consisting of the amorphous inorganic material (joint width), makes it possible for the ballistic performance of a monolithic ceramic to be achieved, which ceramic has a better performance than the edge or triple-point region of a multi-tile solution. The performance can be measured in v50 firing. This is due, inter alia, to an impedance of the glass fraction, the function of the density and speed of sound, which is significantly close to that of the crystalline material than is the case, for example, when using organic adhesives in which the density and speed of sound are significantly lower. The improved mechanical properties of the amorphous inorganic material and any stress that may have been introduced also improve the performance compared with the prior art.

It has also been found that the composite material according to the invention achieves ≥30% of the flexural strength of a monolithic material in a flexural test. As a result, minimizing the glass fraction in the composite material makes it possible to ensure maximum ballistic protection compared with the monolithic solution.

At joint widths of >0.1 mm, preferably >0.4 mm, particularly preferably >0.7 mm, the shockwave that forms when the projectile strikes, and that destroys the crystalline inorganic material of the slabs, is prevented from transitioning to the next slab. Although said composite material reduces the ballistic performance in the region of the wider joint of amorphous inorganic material, compared with a joint of a smaller width, it significantly increases the resistance in the event of repeated firing, because the shockwave stops in the region of the wide joint.

On the basis of the high strength in the bond zone, it is possible to produce parts having a self-supporting surface extension of the planar surfaces of the composite material of greater than 100×100 mm², greater than 1000×1000 mm², or even greater than or equal to 2000×2000 mm², which surfaces originally had to be joined using individual crystalline tiles having a small glass fraction. This is ensured even in the case of a thickness of the crystalline inorganic material of >1 mm, and for ballistic uses in particular >5 mm is suitable, in order to diffract projectiles. The large surface extensions mentioned above are not possible, as a self-supporting monolithic part, except by means of the procedure described in DE102011014100.

In a further embodiment, the same or different 3dimensional geometric shapes, preferably spheres, cylinders and pyramids, consisting of the crystalline inorganic material, are embedded in a matrix of amorphous inorganic material and/or surrounded by the matrix of amorphous inorganic material. The CTE of the amorphous inorganic material is then advantageously greater than that of the crystalline inorganic material, because as a result the volume ratio of the amorphous inorganic material, in particular glass, to the crystalline inorganic material, preferably a ceramic, is significantly greater, and thus the crystalline inorganic material is subjected to compressive stress. This results in an even greater improvement in performance. The composite material of this embodiment has excellent tensile and flexural strength and scratch resistance, because the best material properties of the base materials are combined in an ideal manner. This applies in particular to thin composite materials having a thickness of the crystalline fraction of <2 mm, preferably <0.6 mm, particularly preferably <0.3 mm, bonded to thicker amorphous fractions, in particular the glass fractions, because the crystalline material is subjected to compressive stress, in part or fully, in the case of an optimally adjusted CTE, and is directly and rigidly supported by the amorphous inorganic material. Furthermore, in a particularly preferred embodiment, the amorphous fraction, in particular the glass fraction, can be further strengthened by thermal or chemical hardening.

In a preferred embodiment, the layer of the crystalline inorganic material is thinner than the layer of the amorphous inorganic material. The ratio of the crystalline to the amorphous layer is preferably 1:2, particularly preferably 1:5, most preferably 1:10. As a result, edges, i.e. the narrow flat sides of the geometric 3-dimensional shapes, are virtually invisible, preferably invisible, even in the case of a plurality of crystalline layers side-by-side on a large surface. It is this possible to create planar surfaces from the composite material which have a maximum surface extension of greater than 100×100 mm², or greater than 1000×1000 mm², or even greater than 2000×2000 mm². In this case, the crystalline layers preferably have a thickness of <5 mm, preferably <2 mm, particularly preferably <0.2 mm. If thicknesses of <500 μm, <250 μm, or even <150 μm are used, in the case of a planar design, the joining points are barely visible, and thus aesthetically appealing, even from a distance of >50 cm.

As a result, it is possible to protect even very large surfaces from scratches or from abrasion of a slip-resistant profile. Surfaces of this kind are suitable in particular for transparent glass floors that can be walked on, transparent steps, or illumination glass of large luminaires, for example.

The stress is achieved in that the coefficients of thermal expansion between the amorphous and crystalline material are matched to or designed for one another. In this case, the CTE between 20-300° C. and between 20° C. and the temperature at which log(η)=15, are selected as reference temperatures. This temperatures are dependent on the glass, i.e. are material parameters. The design of the coefficients of thermal expansion of the respective fractions of the composite material is dependent on the volume ratio between the amorphous and the crystalline material. In the case of edge joining, i.e. in the case of an arrangement of the different layers side-by-side, or if the amorphous inorganic material surrounds the crystalline inorganic material, the ratio between the amorphous and the crystalline material (amorphous/crystalline) is <1, preferably <0.2, and particularly preferably <0.1. In the case of surface joining, i.e. an arrangement one on top of the other or an embedded arrangement, the ratio between the amorphous and the crystalline material is >1, preferably 5, and particularly preferably 10.

A particularly advantageous embodiment thus results from matching the coefficients of thermal expansion:

In the case of edge joining: The amorphous inorganic material surrounds or is adjacent to the crystalline inorganic material. Said material is subjected to compressive stress when the coefficient of thermal expansion of the amorphous material is less than that of the crystalline material (CTEₐₘₒᵣₚₕₒᵤₛ<CTE_{crystalline}). In this case, at temperatures of 20-300° C. and a volume ratio of amorphous inorganic material to crystalline inorganic material of <1, preferably <0.2, and particularly preferably <0.1, the coefficients of thermal expansion deviate from one another by ΔCTE≥0.1·10⁻⁶ K⁻¹, preferably by ΔCTE ≥3·10⁻⁶ K⁻¹, particularly preferably by ΔCTE≥6·10⁻⁶ K⁻¹. At temperatures of 20−T(log(η)=15)° C. and a volume ratio of amorphous material to crystalline material of <1, preferably <0.2, and particularly preferably <0.1, the coefficients of thermal expansion also deviate from one another by ΔCTE≥0.1·10⁻⁶ K⁻¹, preferably by ΔCTE≥3·10⁻⁶ K⁻¹, particularly preferably by ΔCTE≥6·10⁻⁶ K⁻¹. In this case, the layer of crystalline inorganic material is preferably surrounded by the amorphous inorganic layer, i.e. in a manner similar to the system of slabs and joints, the layer of the crystalline inorganic material being significantly more extensive, i.e. longer and/or wider, than the layer of amorphous inorganic material, the surface ratio of amorphous to crystalline being ≤1:2, preferably ≤1:5, particularly preferably ≤1:10, and most preferably ≤1:100. In this case, the width of the amorphous inorganic layer between two crystalline inorganic layers is preferably <5 mm, preferably <2 mm, particularly preferably <0.2 mm.

In the case of surface joining: The crystalline material is located above or is embedded in the amorphous inorganic material. Said material is subjected to compressive stress, i.e. mechanical stress, when the coefficient of thermal expansion of the amorphous material is greater than that of the crystalline material (CTEₐₘₒᵣₚₕₒᵤₛ<CTE_{crystalline}). In this case, at temperatures of 20-300° C. and a volume ratio of amorphous inorganic material to crystalline inorganic material of >1, the coefficients of thermal expansion deviate from one another by ΔCTE≥0.1·10⁻⁶ K⁻¹, preferably by ΔCTE≥3·10⁻⁶ K⁻¹, and particularly preferably by ΔCTE ≥6·10⁻⁶ K⁻¹. At temperatures of 20−T(log(η)=15)° C. and a volume ratio of amorphous material to crystalline material of >1, the coefficients of thermal expansion can also deviate from one another by ΔCTE≥0.5·10⁻⁶ K⁻¹, preferably by ΔCTE≥3·10⁻⁶ K⁻¹, and particularly preferably by ΔCTE≥6·10⁻⁶ K⁻¹. In an embodiment in which the layers are arranged on top of one another, the layer of amorphous inorganic material is significantly thicker (higher) than the layer of crystalline inorganic material, the thickness/height ratio of crystalline to amorphous being ≥1:2, preferably ≥1:4, and particularly preferably ≥1:8. In this case, the thickness/height of the crystalline inorganic layer is preferably <5 mm, preferably <2 mm, and particularly preferably <0.2 mm.

After joining, the resulting compressive stress of the crystalline inorganic material fraction and/or of the amorphous inorganic material fraction is then >10 MPa, preferably >100 MPa, and particularly preferably >300 MPa, at least in part.

It is also possible, however, to deviate from the two cases mentioned above, in order to achieve different properties of the composite material according to the invention, such as a particular index of refraction or a particular resistance to chemicals. In this case, deviations of ΔCTE≥6·10⁻⁶ K⁻¹, preferably ΔCTE≥2·10⁻⁶ K⁻¹, particularly preferably ΔCTE≥0 K⁻¹ are possible. The bonding surfaces are particularly important here. The larger the bonding surface, the less the deviation has to be from the above-mentioned cases in order to achieve the required material quality.

In a further embodiment, the linear coefficients of thermal expansion of 20−T(log(η)=15)° C. deviate, between the amorphous inorganic material and the crystalline inorganic material by less than ΔCTE≥5·10⁻⁶ K⁻¹. This is desirable in particular in the case of composite materials having very large joint widths or bond zones, in order to achieve a stress-free state.

In a further embodiment, a preloaded and rigid composite material, having a sandwich structure, is provided. The outer layers consist of the crystalline inorganic material, and the inner matrix consists of the amorphous inorganic material. This sandwich construction of the composite material makes it possible to achieve ultra-rigid glass having a high strength. A particularly preferably use is as cover glass in dive computers. In this case, the rigidity and strength of the composite material according to the invention comes close to the strength of cover layers which are in each case expediently subjected to compressive stress.

Simulations using a sandwich composite material consisting of crystalline-amorphous-crystalline inorganic material, preferably ceramics-glass-ceramics, in order to estimate the ability to withstand stress, have resulted in compressive stresses in the layer of crystalline inorganic material and a strength increase by at least the factor of 2 with respect to the basic strength of the crystalline inorganic material. For this purpose, the thickness ratio between the layer of crystalline inorganic material and the layer of amorphous inorganic material, preferably glass, of the composite material was set at 1:4, and the difference in the thermal expansions at ΔCTE≥5·10⁻⁶ K⁻¹. A ratio of 1:8 or more is also advantageous, since this further increases the compressive stress in the layer of crystalline inorganic material. The direct chemical bond within the composite material means that the ceramic fraction can be of a thickness of 250 μm or less, even in the case of a limited overall thickness, such as in glass for a mobile communications display or notebooks. That is to say that the particularly preferable effect, which is also in accordance with the invention, can also be achieved at overall thicknesses of <1 mm, <0.6 mm or even <0.4 mm.

In addition to the above-mentioned introduction of internal compressive stresses, the composite material can also be further strengthened by thermal or chemical stressing of the amorphous fraction. Thus, in one embodiment, in addition to the crystalline inorganic material that is subjected to compressive stress, the amorphous inorganic material is also subjected to compressive stresses. This is achieved by means of the outer shell of the glass fraction in the composite material being subjected to internal compressive stresses by the above-mentioned hardening/preloading processes. In this case, the thermal hardening and the creation of the composite material can be performed in a process in a hardening furnace.

A further advantage of the composite material is the improved optical properties which are achieved by very thin layers of the crystalline inorganic material. The transmission increases, and haze (white cloudiness) and the frequency of blemishes are minimized.

This is particularly advantageous for watches, camera lenses, laser protection glasses, scanner disks and mobile telephones. Furthermore, thinner layers reduce costs. There are generally fewer defects in thinner layers, and therefore higher optical quality can be achieved. Scrap is thus reduced. Furthermore, fewer raw materials are required, and the use of processes suitable for mass production from glass finishing makes it possible to unify the processes.

When thin crystalline layers of <200 μm, preferably <100 82 m, are used, visible lines (at the edges, due to total internal reflection) are prevented, as a result of which the component optics is again improved.

The temperature resistance of the composite material according to the invention is significantly improved, compared with composite materials comprising organic adhesives, because the crystalline inorganic material generally has melting temperatures of >1500° C., and the amorphous inorganic material softens at temperatures that are comparatively high for technical applications. This results in a temperature resistance of at least >400° C., preferably >600° C.

The composite material according to the invention can be used in a plurality of different technical fields, some of which are already mentioned in the present introduction. The following possible fields of use for the composite material are not intended to limit the invention thereto, however.

In personal protection, the composite materials according to the invention can be used for example for ballistic protective glass. The shock resistance and the resistance to environmental influences are of decisive importance in this case. Owing to the crystalline material, the composite materials have greater ballistic protection performance, and therefore the panels of the composite material can be made thinner. Panels of the composite material thus have a lower weight per unit are than comparable panels on the basis of glass (bulletproof glass).

Use in civil fields of application, in which usually relatively thin material components are used, is also possible on account of the new composite material according to the invention.

An example for this is the use in the field of architecture (e.g. glass that can be walked on). Permanent prevention of scratches or ensuring slip resistance (a slip-resistant profile does not wear away or is not abraded in another manner) means that crystalline materials have significant, also safety-relevant, advantages in the architectural field.

In the case of constant stress in the public region, the desired scratch resistance can be achieved only with difficulty using amorphous materials, in particular glass. The same applies for a permanently profiled slip-resistant surface. The composite material, in which the crystalline material, in particular the transparent ceramic, is arranged on the outer face, can thus combine the advantages of amorphous and crystalline materials.

Another application for the composite material according to the invention is the use as a large window in the high-temperature range (>600° C.). In this case, it is again difficult to use a pure crystalline material, individual parts being bonded by an organic matrix, because the temperature resistance of the organic bonds is usually not sufficient. In contrast thereto, however, a composite material according to the invention can be used without problem.

In addition, it is possible to use the composite material according to the invention in applications that require very thin layers. The composite material according to the invention can thus be used as screen covers in smartphones, notepads or smart watches (layer thicknesses of <2000 μm, usually even <1000 μm or even <500 μm). Said display covers require excellent optical (>90% relative transmission, low white cloudiness (haze)) and mechanical properties (high strength, excellent scratch resistance, high resistance to sharp impacts).

A disadvantage of the glass used hitherto is that said glass is still sensitive to scratches and the glass is destroyed when the internal compressive stress zone is passed through. All glass comprising mineral substances having a Mohs hardness of ≤6 can thus be scratched and broken through. This means that many common natural materials such as sand, stone, concrete, asphalt, glass, etc. result in significant scratching or breakage when subjected to sharp impact of a glass component. Pure crystalline materials often have greater resistance to scratching and are also more resistant to sharp impacts, owing to the high compressive strength thereof, but have low tensile or flexural strengths.

A further possible application is that of curved surfaces, such as in helmet visors. Curved manufacture of the crystalline materials is extremely complex and costly. When thin pure crystalline materials are used, however, said materials are flexible and therefore significantly curved surfaces, such as helmet visors, are possible. The stability, which is no longer sufficient when wall thicknesses are too low, has hitherto prevented use. However, the composite material according to the invention exhibits said mechanical stability

A field in which mechanically particularly stiff, but nonetheless very solid, glass is required is the field of pressure windows, such as in dive computers. Particularly thin glass is desirable in this case. In the case of glass, the thickness is usually limited by the maximum bending (e-modulus >120 GPa). Use of crystalline materials is not possible owing to the above-described limited strength, and sometimes also on account of costs being too high. However, the composite material according to the invention is cheaper to produce and also exhibits the necessary strength.

Pure crystalline materials have an extremely high potential in the field of optically demanding applications (e.g. optical lenses) too. Optical applications require a lack of defects, high transmission, and low white cloudiness (“haze”).

Although the crystalline materials often have particularly desirable properties such as indices of refraction of >2.1 (zirconium oxide), high hardness levels (spinel or aluminum oxide), potential for large dopant fractions (YAG), or high temperature resistance, which is limited in each case when using amorphous materials, use of said crystalline materials is often problematic. This is because a transparency close to the theoretically possible transparency is far harder to achieve in crystalline materials compared with amorphous materials, and is limited by additional absorption, scattering (by more boundary layers of the crystals or pores) and a high reflection fraction.

However, thicknesses of <2 mm are particularly advantageous for high transmission, because the light transmission has an exponential correlation, according to the material thickness, and absorption and scattering effects reduce dramatically. As described above, however, the mechanical resistance of the parts also reduces significantly as the thickness reduces, and therefore the parts consisting of crystalline materials cannot be produced so as to be as thin as desired but still usable.

In general terms, the composite material according to the invention overcomes the disadvantages both of the amorphous materials and of the crystalline ceramic materials. If the crystalline material is located on the outer face of the component, the scratch resistance is increased and the behavior in the case of a hard impact is improved. At the same time, the combination with an (underlying) amorphous material significantly improves the flexural strength properties of the composite material and makes it possible to use ceramics materials for a very wide range of applications.

Furthermore, the composite material according to the invention can also be used for further special applications.

An application of this kind is the use as laminates for IR applications. The system described in WO2015118079 A1 furthermore has the disadvantage that, even if the substrate and crystalline material exhibit high transmission over a wide wavelength range (e.g. spinel 200 nm-6000 nm), the transmission is significantly influenced by the use of organic bonding agents because the transmission of said substances is often either limited at a maximum of 3000 nm, because the absorb or scatter a significant fraction of the light at this point, or said substances are simply significantly less chemically resistant, which rules out the possibility of application in many fields. This is important in particular for applications such as measuring devices that operate in the IR range, for example pyrometers, night vision devices, IR cameras, spectrometers, etc.

According to the invention, the composite material makes it possible to create infrared-permeable parts, having improved properties compared with the prior art, for use as pyrometers, night vision devices, IR cameras and spectrometers. Firstly, the IR-permeability, compared to organic adhesives, is possible up to higher wavelengths (<4000-5000 nm). It is even possible to use IR-permeable glass up to a wavelength of 12,000 nm, the crystalline material then constituting the transmission-limiting component. Furthermore, amorphous glass materials are significantly more environmentally resistant (e.g. to UV light or acid rain). IR-transparent composite materials result that have a transmission of >70%, preferably >80%, and particularly preferably >85% in the range of λ=2000 nm to 4000 nm.

A further special application of the composite material according to the invention is that of transparent applications in the medical field, for example the intracorporeal use of optics. Particular advantages of materials such as sapphire or spinel are the inertness or biocompatibility thereof, as well as the high chemical and mechanical resistance thereof compared with amorphous solutions such as glass. Housings formed in multiple parts, from crystalline materials, for in-vivo use can be bonded using glass adherends that are cut to size. This results, for the first time, in bioinert and tight separation. Local heating of low-melting glass (<500° C.) using a laser is considered particularly preferable for protecting the electronic interior.

A further field in which the use of crystalline materials is of great interest is the production and use of pipes, since the high hardness thereof makes said pipes particularly scratch-resistant and thus maintains the surface quality in the long term. Furthermore, the chemical resistance and the optical features, such as particular indices of refraction, are also again of significance. A problem specifically in the case of pipes having a high length-to-diameter ratio is the interior polishing of said pipes. This is sometimes not possible at all, or possible only with significant effort.

In order to achieve the required transparency in ceramics pipes, laborious and sometimes impossible interior polishing is necessary. If a ceramics pipe on the outside and a glass pipe on the inside are bonded together, i.e. the composite material is a tubular element, the process of interior polishing is no longer required. The outer casing of the ceramics pipe is polished, the inner casing merely being pre-ground or precision ground. According to the invention, the ceramics pipe and glass pipe are bonded for example in a vacuum furnace, in the transformation range of the glass. The glass pipe softens and bonds to the ceramics at the ceramics-glass boundary layer, and assimilates the surfaces such that a transparent surface results. The heat-treatment itself also makes the inner surface of the glass fraction transparent. In a preferred embodiment, the inorganic crystalline material of the tubular composite material according to the invention is subjected to internal compressive stress.

In summary, the composite material according to the invention can thus be used for screens, ballistic protective glass, spectacles glass, watch glass, steps, glass that can be walked on, dive computers, recessed floor luminaires, scanner disks, visors, sensors, camera ports, optical lenses, furnace windows, machine panes, or housings for intracorporeal use. As a result, in particular the shock-resistant increases compared with soft (compared with the crystalline materials) objects (e.g. steel balls), and the sharp impact behavior is significantly improved by the hard crystalline material. The composite material results in products that are significantly more robust compared with the existing material solutions.

The invention will be illustrated in the following figures and examples, in which:

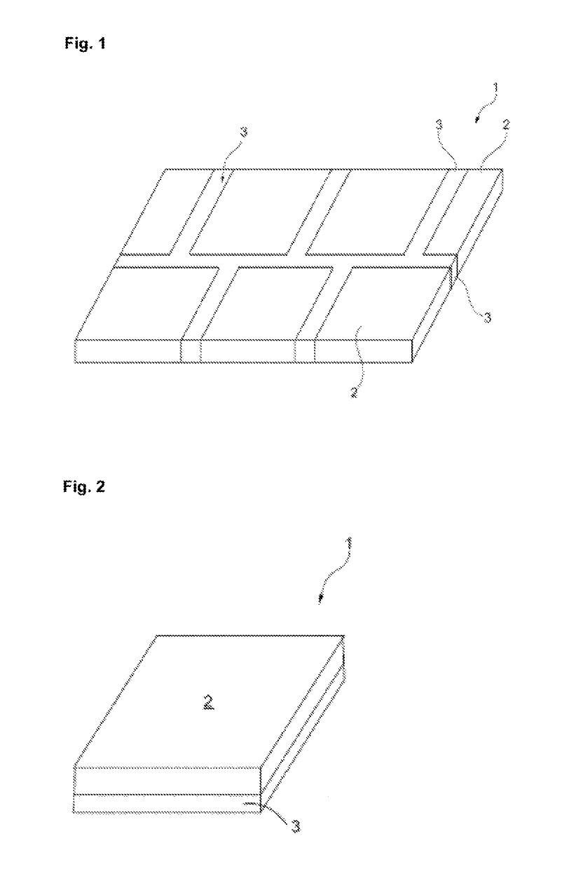

FIG. 1 shows a composite material (1), consisting of a plurality of layers of the transparent crystalline inorganic (2) and amorphous inorganic material (3) (arranged in a surrounding manner)

FIG. 2 shows a composite material (1), consisting of a plurality of layers of the transparent crystalline inorganic (2) and amorphous inorganic material (3) (arranged on top of one another)

FIG. 1 shows an embodiment of a composite material 1 according to the invention. In this embodiment, said composite material consists of layers of the crystalline inorganic material 2 which are surrounded by layers of the amorphous inorganic material 3. As shown, the crystalline inorganic layers 2 can have different external dimensions. As described above, the crystalline inorganic layers 2 can be positioned such that the amorphous inorganic material 3 bonds said crystalline inorganic layers in the manner of a joint. Subsequently, said arrangement is tempered, resulting in the composite material 1.

FIG. 2 shows a composite material 1 according to the invention which consists of layers of the crystalline inorganic material 2 and layers of the amorphous inorganic material 3, which layers are arranged on top of one another. As shown, the crystalline inorganic layers 2 and the amorphous inorganic layers 3 can have different external dimensions. Subsequently, said arrangement is tempered, resulting in the composite material 1.

### LIST OF REFERENCE SIGNS

1. composite
2. crystalline inorganic material
3. amorphous inorganic material

### EXAMPLE 1

2 and 4 ceramics tiles consisting of magnesium aluminum spinel, of a size of 90×90×7 mm and 45×45×7 mm, were heated, together with glass of a thickness of 500 μm having an index of refraction of n=1.72±0.03 at λ=588 nm, a CTE of 7.0·10⁻⁶ K⁻¹ at a temperature of between 20 and 300° C., and a transformation range of ˜610-680° C., to over 600° C., kept there, and cooled in a controlled manner. The arrangement resulted in a planar, extensive composite material having edge joining, in which the amorphous inorganic material surrounds the crystalline inorganic material in part.

After the lower relaxation limit of the glass had been exceeded, an edge join was formed between the glass and the ceramics, and the bone zone was subjected to compressive stress. The composite material thus produced has a transmission of >70% in the VIS range, in the bond region, and no total internal reflection was identified. UV tests, climatic resistance according to the MIL standard, and further processing in an autoclave, at temperatures of >80° C. and a pressure of >4 bar were ensured or could be performed in an error-free manner.

### EXAMPLE 2

Boron silicate glass, of a thickness of 1 mm and having a transformation range of between 620° C. and 700° C. and a CTE of 7.0·10⁻⁶ K⁻¹, was placed on (on top of) and thermally bonded on a planar magnesium aluminum spinel ceramics material, polished on both sides and of a size of 150×100×0.2 mm, in a furnace, at a temperature of between 20 and 300° C., to form a composite material, such that the component became optically homogeneous and has a transmission of >80%. The treatment temperature was >600° C.

The composite material thus produced exhibits surface joining between the crystalline inorganic material and the amorphous inorganic material, and was subsequently loaded, at 500 N and by a steel ball having a diameter of 10 mm, on a steel substrate and using a Zwick testing machine, without the composite material being damaged.

### EXAMPLE 3

In a further test, the composite material achieved in Example 2 underwent a chemical hardening process that is conventional for glass material. The composite material thus achieved had an overall strength of σ˜580 MPa, in a ring on ring flexural strength test.

### EXAMPLE 4

In a further example, the procedure was performed as in Example 2, but the glass used had a CTE of 10.4·10⁻⁶ K⁻¹ at a temperature of between 20 and 300° C., and had a thickness of 800 μm, and the ceramics had a thickness of 200 μm. As a result, a sandwich composite was produced by means of joining in a furnace.

The present invention is characterized in particular by the following preferred embodiments:

Embodiment 1: Composite material, characterized in that an amorphous inorganic material is bonded to a transparent crystalline inorganic material.

Embodiment 2: Composite material according to embodiment 1, wherein the amorphous inorganic material is a glass.

Embodiment 3: Composite material according to embodiment 1, wherein the amorphous inorganic material is a metal.

Embodiment 4: Composite material according to embodiment 1, wherein the crystalline inorganic material is a monocrystal.

Embodiment 5: Composite material according to embodiment 1, characterized in that the crystalline inorganic material is a polycrystalline ceramics.

Embodiment 6: Composite material according to any of embodiments 1-5, wherein the amorphous inorganic material is formed together with the transparent crystalline inorganic material, by means of transient bonding between softened amorphous inorganic material and crystalline inorganic material, and exhibits an integral bond after cooling.

Embodiment 7: Composite material according to any of embodiments 1-5, wherein the amorphous inorganic material is integrally bonded to the transparent crystalline inorganic material by means of ionic or covalent bonding, optionally forming a reaction zone.

Embodiment 8: Composite material according to either embodiment 6 or embodiment 7, wherein the viscosity of the amorphous inorganic material has changed during the joining process.

Embodiment 9: Composite material according to any of embodiments 6-8, wherein the crystalline inorganic material and/or the amorphous inorganic material has a compressive stress of >10 MPa, preferably >100 MPa, more preferably >300 MPa, at least in part, after joining.

Embodiment 11: Composite material according to any of claims 1-9, wherein the crystalline material is a cubic polycrystalline oxide ceramics of the system of aluminum, magnesium or aluminum and yttrium, or zirconium oxide and yttrium, or aluminum oxynitride.

Embodiment 12: Composite material according to any of embodiments 1-11, wherein the indices of refraction of the amorphous inorganic material and of the transparent crystalline inorganic material deviate from one another by less than 0.4, preferably by less than 0.2, and particularly preferably by less than 0.15 at λ=550-650 nm.

Embodiment 13: Composite material according to any of embodiments 1-11, wherein, between the two temperatures of 20-300° C. and a volume ratio of amorphous inorganic material to crystalline inorganic material of >1, the coefficients of thermal expansion deviate from one another by ΔCTE≥0.1·10⁻⁶ K⁻¹, preferably by ΔCTE≥3·10⁻⁶ K⁻¹, particularly preferably by ΔCTE≥6·10⁻⁶ K⁻¹, wherein the CTEₐₘₒᵣₚₕₒᵤₛ is greater than the CTE_{crystalline}.

Embodiment 14: Composite material according to any of embodiments 1-11, wherein, between the two temperatures of 20−T(log(η)=15)° C. and a volume ratio of amorphous inorganic material to crystalline inorganic material of >1, the coefficients of thermal expansion deviate from one another by ΔCTE≥0.5·10⁻⁶ K⁻¹, preferably by ΔCTE≥3·10⁻⁶ K⁻¹, particularly preferably by ΔCTE≥6·10⁻⁶ K⁻¹, wherein the CTEₐₘₒᵣₚₕₒᵤₛ is greater than the CTE_{crystalline}.

Embodiment 15: Composite material according to either embodiment 13 or embodiment 14, wherein the crystalline inorganic material, preferably ceramics, is significantly thinner than the amorphous inorganic material, wherein the thickness ratio of crystalline to amorphous is ≤1:2, preferably ≤1:4, particularly preferably ≤1:8.

Embodiment 16: Composite material according to any of embodiments 1-11, wherein, between the two temperatures of 20-300° C. and a volume ratio of amorphous inorganic material to crystalline inorganic material of <1, preferably <0.2, and particularly preferably <0.1, the coefficients of thermal expansion deviate from one another by ΔCTE≥0.1·10⁻⁶ K⁻¹, preferably by ΔCTE≥3·10⁻⁶ K⁻¹, particularly preferably by ΔCTE≥6·10⁻⁶ K⁻¹, wherein the CTEₐₘₒᵣₚₕₒᵤₛ is smaller than the CTE_{crystalline}.

Embodiment 17: Composite material according to any of embodiments 1-11, wherein, between the two temperatures of 20−T(log(η)=15)° C. and a volume ratio of amorphous inorganic material to crystalline inorganic material of <1, preferably <0.2, and particularly preferably <0.1, the coefficients of thermal expansion deviate from one another by ΔCTE≥0.1·10⁻⁶ K⁻¹, preferably by ΔCTE≥3·10⁻⁶ K⁻¹, particularly preferably by ΔCTE≥6·10⁻⁶ K⁻¹, wherein the CTEₐₘₒᵣₚₕₒᵤₛ is smaller than the CTE_{crystalline}.

Embodiment 18: Composite material according to either embodiment 16 or embodiment 17, wherein the crystalline inorganic material, preferably the ceramics, is significantly more extensive than the amorphous inorganic material, wherein the surface ratio of amorphous to crystalline is ≤1:2, preferably ≤1:5, particularly preferably ≤1:10, most preferably ≤1:100.

Embodiment 19: Composite material according to any of embodiments 1-18, wherein the composite material consists of a plurality of layers of the crystalline inorganic material and comprises a matrix of amorphous inorganic material.

Embodiment 20: Composite material according to embodiment 19 which is joined such that planar surfaces result.

Embodiment 21: Composite material according to embodiment 20, having a maximum surface extension of greater than 100×100 mm², preferably greater than 1000×1000 mm², particularly preferably greater than 2000×2000 mm².

Embodiment 22: Composite material according to any of embodiments 1-21, wherein fewer glass elements, together with more ceramics elements, are formed into a surface.

Embodiment 23: Composite material according to embodiment 21, wherein the ceramics thickness is <5, preferably <2, particularly preferably <0.2 mm.

Embodiment 24: Composite material according to embodiment 15, wherein the ceramics thickness is <5, preferably <2, particularly preferably <0.2 mm.

Embodiment 25: Composite material according to embodiment 18, wherein the ceramics thickness is <5, preferably <2, particularly preferably <0.2 mm.

Embodiment 26: Composite material according to either embodiment 24 or embodiment 25, wherein the amorphous inorganic material, preferably the glass, was thermally stressed after joining.

Embodiment 27: Composite material according to either embodiment 24 or embodiment 25, wherein the amorphous inorganic material, preferably the glass, was thermally stressed after joining.

Embodiment 28: Composite material according to either embodiment 26 or embodiment 27, wherein the outer layers of crystalline inorganic material, preferably of ceramics, are subjected to compressive stress, i.e. mechanical stress.

Embodiment 29: Composite material according to any of embodiments 1-28, wherein said composite material has a transmission, in the range of λ=2000 nm to 4000 nm, of >70%, preferably >80%, particularly preferably >85%.

Embodiment 30: Composite material according to any of embodiments 1-29, wherein the amorphous inorganic material has an index of refraction of >1.6, preferably ≥1.65, particularly preferably 1.7.

Embodiment 31: Composite material according to any of embodiments 1-30, wherein both the crystalline inorganic material and the amorphous inorganic material have a temperature resistance (softening temperature) of >400° C., preferably >600° C.

Embodiment 32: Composite material according to any of embodiments 1-31, wherein a plurality of layers of the crystalline inorganic material, preferably the ceramics, are combined to a thickness of >20 mm, preferably >30 mm, particularly preferably >40 mm.

Embodiment 33: Composite material according to any of embodiments 1-19 or 22-29, wherein the composite material is tubular.

Embodiment 34: Composite material according to any of embodiments 1-33, wherein the amorphous inorganic material compensates for unevenness of the crystalline inorganic material (index of refraction and wetting).

Embodiment 35: Composite material according to any of embodiments 1-34, wherein the amorphous inorganic material is a glass comprising 0-15 mol. % lanthanum, 0-15 mol. % lead, 0-15 mol. % barium, and silicon and/or aluminum and/or boron.

Embodiment 36: Composite material according to any of embodiments 1-35, wherein the bond between amorphous inorganic material and crystalline inorganic material is created by using a vacuum furnace, a normal furnace, a thermal tempering furnace, a heating press, a hot isostatic press, a FAST or SPS.

Embodiment 37: Composite material according to any of embodiments 1-36, wherein the bond is created by joining surfaces having a roughness Ra of <1 μm, preferably <0.1 μm, and particularly preferably <0.01 μm.

Embodiment 39: Composite material according to either embodiment 6 or embodiment 7, wherein the amorphous inorganic material has a minimum viscosity of log(η)≤15, preferably log(η)≤13, particularly preferably log(η)≤8 during joining.

Embodiment 40: Composite material according to any of embodiments 13-15, wherein the crystalline inorganic material has a compressive stress of >10 MPa, preferably >100 MPa, particularly preferably >300 MPa, at least in part, after joining.

Embodiment 41: Composite material according to any of embodiments 13-15, wherein the crystalline inorganic material and the amorphous inorganic material have a compressive stress of >10 MPa, preferably >100 MPa, particularly preferably >300 MPa, at least in part, after joining.

Embodiment 42: Composite material according to any of embodiments 16-18, wherein the amorphous inorganic material has a compressive stress of >10 MPa, preferably >100 MPa, particularly preferably >300 MPa, at least in part, after joining.

Embodiment 43: Use of the composite material according to any of embodiments 1-40 as a screen, ballistic protective glass, spectacles glass, watch glass, steps, glass that can be walked on, dive computers, recessed floor luminaires, scanner disks, visors, sensors, camera ports, optical lenses, furnace windows, machine panes, or housings for intracorporeal use.

The present invention relates to a transparent composite material for various applications, consisting of crystalline and amorphous inorganic material having improved material properties.

1. Composite material, comprising amorphous inorganic material is directly bonded to a transparent crystalline inorganic material.

2. Composite material according to claim 1, wherein the amorphous inorganic material is a glass or a metal.

3. Composite material according to claim 1, wherein the transparent crystalline inorganic material is a monocrystal or a polycrystalline ceramics.

4. Composite material according to claim 1, wherein the transparent crystalline inorganic material is selected from oxides of the compounds comprising Al and/or Mg and/or yttrium; nitrides, oxynitrides or sulfides of aluminum or silicon; oxides of zirconium and/or yttrium, aluminum oxynitride; zinc sulfide; silicon carbide, boron carbide, boron nitride, carbon, lanthanum-doped lead zirconate titanate, or fluoride of Ca and/or Mg and/or aluminum having up to 5% dopants of the group consisting of the lanthanoids and/or actinides and/or ferrous or non-ferrous metals, or mixtures thereof.

5. Composite material according to claim 1, wherein the amorphous inorganic material has an index of refraction of >1.6.

6. Composite material according to claim 1, wherein the composite material has a temperature resistance of at least >400° C.

7. Composite material according to claim 1, wherein the amorphous inorganic material and/or the crystalline inorganic material have a compressive stress of >10 MPa, at least in part, in the composite material.

8. Composite material according to claim 1, wherein the amorphous inorganic material has a minimum viscosity of log(η)≤15, during production.

9. Composite material according to claim 1, wherein between the two temperatures of 20-300° C. and a volume ratio of amorphous inorganic material to crystalline inorganic material of >1, the coefficients of thermal expansion deviate from one another by ΔCTE≥0.1·10⁻⁶ K⁻¹, the CTEₐₘₒᵣₚₕₒᵤₛ being greater than the CTE_{crystalline}.

10. Composite material according to claim 9, wherein the crystalline inorganic material, preferably ceramics, is significantly thinner than the amorphous inorganic material, the thickness ratio of crystalline to amorphous being ≤1:2.

11. Composite material according to claim 1, wherein between the two temperatures of 20-300° C. and a volume ratio of amorphous inorganic material to crystalline inorganic material of <1, the coefficients of thermal expansion deviate from one another by ΔCTE≥0.1·10⁻⁶ K⁻¹, the CTEₐₘₒᵣₚₕₒᵤₛ being less than the CTE_{crystalline}.

12. Composite material according to claim 11, wherein the width of the amorphous inorganic layer between two crystalline inorganic layers is <5 mm.

13. Composite material according to claim 1, wherein the amorphous inorganic material is formed together with the transparent crystalline inorganic material, by means of transient bonding between softened inorganic material and crystalline material, and exhibits an integral bond after cooling.

14. Composite material according to claim 1, wherein the bond is created by joining surfaces having a roughness Rₐ of <1 μm.

15. Use of the composite material according to claim 1 as a screen, ballistic protective glass, spectacles glass, watch glass, steps, glass that can be walked on, dive computers, recessed floor luminaires, scanner disks, visors, sensors, camera ports, optical lenses, furnace windows, machine panes, or housings for intracorporeal use.
